(19) United States
(12) Patent Application Publication
(10) Pub. No.: US 2008/0172404 A1
(43) Pub. Date: Jul. 17, 2008

(54) METHOD AND APPARATUS FOR BOOKMARKING UNIFORM RESOURCE IDENTIFIERS THAT ARE SUBJECT TO REDIRECTION

(75) Inventor: Norman H. Cohen, Suffern, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/623,911

(22) Filed: Jan. 17, 2007

(51) Int. Cl. G06F 17/30

(52) U.S. Cl. 707/102; 707/E17.044

(57) ABSTRACT

A system, method and computer program product that enables retrieval of a web page that was previously retrieved by a browser device as a result of issuing an HTTP request with a given request URI that resulted in a redirection response from a server device. The system implements the use of bookmarks to retrieve a web page that was retrieved earlier using a given request URI by associating a request URI with a bookmark stored in a browser; later reference to the bookmark initiates retrieval of the web page identified by the URI associated with that bookmark. The association between the request URI and the bookmark is distributed between the browser and the web server. In a second aspect of this invention, the association is stored entirely in the browser.

### BACKGROUND OF THE INVENTION

1. Field of the Invention

The present invention relates to a method and apparatus for using a bookmark to retrieve a web page when the URI (Uniform Resource Identifier) used in the request that led to the creation of the bookmark resulted in a redirection response.

2. Description of the Related Art

Web browsers and web servers communicate through the Hypertext Transfer Protocol, HTTP. One feature of this protocol is redirection: A web server can service a request with one URI (the request URI) by redirecting the browser to another URI (the redirection URI) at which the information sought by the original request can be retrieved. Specifically, a browser sends an HTTP request to the request URI and receives a redirection response. The redirection response contains a status code in the range 300-399, indicating that the request has been redirected, and specifies the redirection URI. Upon receiving such a response, the browser issues an HTTP request to the redirection URI. (This process may be repeated.)

When a current web browser receives a redirection response, it replaces the request that had been displayed in the browser address window with the redirection URI. If the user of the browser bookmarks the pages (a process referred to in some browsers as adding the page to list of “favorites”), it is the redirection URI that is recorded in the bookmark. This is unfortunate, because the request URI is often more stable than the redirection URI. That is, the redirection URI may cease to function, and the request URI may continue to redirect the browser to an appropriate page. There are several reasons this might be the case:
There might be multiple URIs corresponding to successive versions of a document (such as a proposed standard or a piece of downloadable software), and one fixed URI that is adjusted, whenever a new version is created, to be redirected to the most current version. The user's intent might be to maintain a bookmark that always retrieves whichever version is the most current version at the time the bookmark is followed.
A front-end server might redirect HTTP requests to a variety of other servers to achieve load balancing; the server to which redirection takes place depends on current loads, and may be partly random. The server in the redirection URI may host the web page only temporarily, under certain load conditions. At other times, bookmarks to the redirection URI will not work.
Different organizations may take turns hosting a web site for a particular purpose. For example, a conference may have a web site on a different server (with its own URI) each year, maintained by that year's conference chair, and there may be a permanent conference URI that is adjusted each year to redirect HTTP requests t the server maintained by that year's conference chair. The intent of the web-browser user may be to maintain a permanent bookmark for accessing whatever site happens to be the latest conference web site at the time the bookmark is followed.

In each of these situations, it would be better for a browser to bookmark the request URI, but current browsers bookmark the redirection URI.

There are also situations in which it is preferable to bookmark the redirection URI, as when a website has been permanently moved to a new server, or a website has been reorganized, or a web server has been renamed (e.g., because the name of the corporation hosting the server has changed.) In these cases, the request URI is obsolete, and it is preferable (for reasons of efficiency and because the obsolete URI may one day disappear) to use the redirection URI in all future searches.

Internet Engineering Task Force (IETF) Request for Comments (RFC) 2616, defining version 1.1 of the Hypertext Transfer Protocol (HTTP) (at http://www.ietf.org/rfc/rfc2616.txt), specifies that a server should return a status code of 301 to indicate that the resource originally identified by the request URI has been permanently assigned a new URI that should be used in all future requests; and a status code of 302 or 307 to indicate that the resource originally identified by the request URI resides temporarily under a new URI, but that the request URI should continue to be used in future requests. Note 28 “Common User Agent Problems,” published by the World Wide Web Consortium (W3C), (at http://www.w3.org/TR/cuap) enumerates common ways in which browsers fail to conform to RFC 2616, and specifically asserts, “The user should be able to bookmark, copy, or link to the original (persistent) URI or the result of a temporary redirect.” Note 28 states that, in contrast to this advice, “user agents” (i.e., browsers) “usually show the user (in the user interface) the URI that is the result of a temporary (302 or 307) redirect, as they would do for a permanent (301) redirect.”

### SUMMARY OF THE INVENTION

To enable the use of bookmarks to retrieve a web page that was retrieved earlier using a given request URI, the current invention associates that request URI with a bookmark stored in a browser; later reference to the bookmark initiates retrieval of the web page identified by the URI associated with that bookmark. In one aspect of this invention, the association between the request URI and the bookmark is distributed between the browser and the web server. In a second aspect of this invention, the association is stored entirely in the browser.

Thus, according to a first aspect of the invention, there is provided a system and method of retrieving, in response to a later HTTP request by a requester, a web page retrieved by a browser device in response to an earlier redirected HTTP request, the method comprising:

at the server device, generating a redirection response to said earlier redirected HTTP request, and generating and storing a record associating the redirection URI in said redirection response with the request URI in said earlier redirected HTTP request;

storing, at said browser device, said redirection URI in a bookmark;

retrieving, at said browser device, the URI associated with said bookmark by issuing said later HTTP request, using the redirection URI stored in said bookmark as the request URI of said later HTTP request;

receiving, at said server device, said later HTTP request and searching for a record associating the request URI of said later HTTP request with the request URI of some earlier redirected HTTP request;

upon finding such a record, said server device processing said later HTTP request as if its request URI were said request URI of some earlier redirected HTTP request in said found record, wherein a web page identified by the request URI of said earlier redirected HTTP request is retrieved through said bookmark.

Further to this aspect of the invention, a unique record associating the given redirection URI returned in response to a request with the given request URI is generated for each user of the browser device. Thus, in response to receiving, at the server device, a given HTTP request with a given request URI from a given user, the server device:

searches for the record of the given URI having been returned as a redirection URI in response to a request from the given user with some request URI; and,

upon accessing the record, processes the given HTTP request as if it contained the given request URI.

Furthermore, the server device that generates a record associating the given redirection URI returned in response to a request with the given request URI may be the same as or different from the server device receiving the given HTTP request with a given URI.

According to a further aspect of the invention, there is provided a method of bookmarking a web page by a browser device as a result of issuing an HTTP request with a given request URI that resulted in a redirection response from a server device. The method comprises:

receiving an HTTP response from the server device, and

creating, at the browser device, at the initiation of the user of the browser device, a bookmark for the given request URI in the HTTP request, even if the request was redirected to another URI by the server device.

Further in accordance with this aspect of the invention, prior to the creating, the steps of:

determining whether the HTTP response received is a redirection response from the server device; and, in response to the determining,

enabling the browser device to create, at the initiation of the user of the browser, one of: a bookmark referring to the original given request URI that was subject to redirection, or a bookmark referring to the redirection URI in the received HTTP response.

Additionally, the present invention is directed to a system for retrieving web pages comprising:

a computing device for receiving an HTTP request with a given request URI;

a means implemented in the computing device for determining whether a given request URI results in a redirection response and providing a redirection URI in response to a given request that results in the redirection;

a means associated with the computing device for generating a data structure associating the given redirection URI returned in response to a request with the given request URI;

a storage means for storing the generated data structure;

a browser device for storing a bookmark associated with a URI, the redirection URI being returned by the computing device in the bookmark, the browser device retrieving the URI associated with the bookmark by issuing an HTTP request including the redirection URI stored in the bookmark; and,

a means implemented in the computing device for searching for the data structure of the given URI having been returned as a redirection URI in response to a request with a request URI, and, upon accessing the data structure, initiating the computing device to process the given HTTP request as if it contained the given request URI,

wherein a web page identified by the given request URI associated with the given stored bookmark is retrieved.

Advantageously, the invention enables provisioning of a service that generates HTTP responses in response to HTTP requests, wherein the service comprises:

receiving HTTP requests at a computing device, each HTTP request associated with a given original request URI;

determining, at the computing device, whether a given request URI results in a redirection response and providing a redirection URI in response to a given original request that results in the redirection; and

responding at the computing device to any subsequent HTTP request from the same requestor in which the request URI is the given redirection URI as if the request URI in the subsequent HTTP request were replaced by the given original request URI.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a system implementing the distributed maintenance of associations between bookmarks and request URIs;

FIG. 2 is an activity diagram illustrating the interaction between the web browser and web server of FIG. 1 when the browser bookmarks a redirected page and the server is later adjusted to redirect the original request URI elsewhere;

FIG. 3 is a flow diagram of the GUI event-loop of a browser implementing browser-only maintenance of associations between bookmarks and request URIs;

FIG. 4 depicts an exemplary browser options dialog allowing the user of the browser to set a permanent preference for the bookmarking of redirected pages;

FIG. 5 depicts an exemplary browser options dialog allowing the user of the browser to set permanent preferences for the bookmarking of redirected pages based on the status codes of the HTTP redirection responses;

FIG. 6 depicts an exemplary dialog for specifying how an individual redirected page is to be bookmarked; and

FIG. 7 depicts an exemplary browser window with a toolbar that displays both the URI that the user entered and the URI of the page actually displayed, and provides separate buttons for bookmarking either URI.

### DETAILED DESCRIPTION OF THE PREFERRED EMBODIMENT OF THE INVENTION

The key to using a bookmark to retrieve a web page that was retrieved earlier using a given request URI is to establish an association between a bookmark and that request URI. In the distributed aspect of this invention, this association is maintained partly in a web browser and partly on a web server. In the browser-only aspect of this invention, this association is maintained exclusively in a browser.

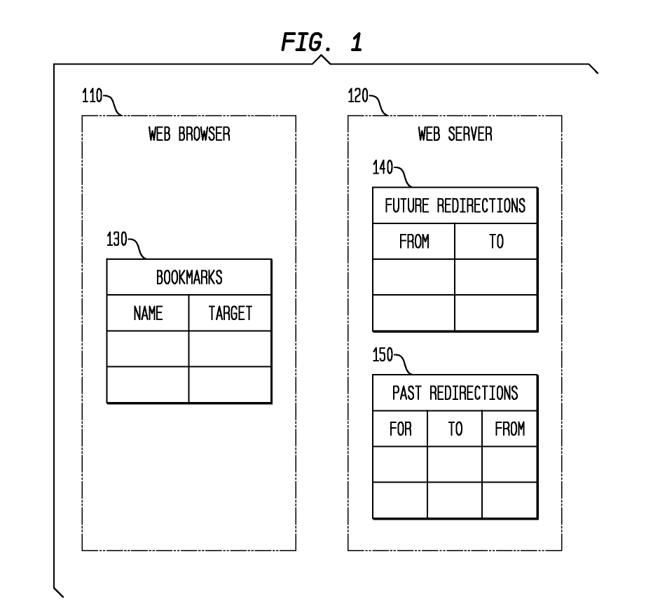

The distributed aspect can be implemented entirely by changes at the web server, using current web browsers. It can be viewed as a server-side fix to the problem of web browsers that do not distinguish among redirection status codes. FIG. 1 illustrates a system implementing the distributed aspect. The system consists of a web browser device 110, i.e., a general-purpose device running, among other things, a browser program or web browser agent, and a web server 120. The web browser 110 includes a bookmark mapping 130 from bookmark names to target URIs. Most current browsers contain some implementation of the bookmark mapping, possibly using list, tree, or hash-table data structures. The mapping associates a bookmark name with the URI at which content was actually found, which may be the original request URI for some bookmarks and may be a redirection URI for other bookmarks. Most current web servers include some implementation of a future-redirections mapping 140 used to generate redirection responses. In the current invention, the web server 120 also includes a past-redirection relation 150 recording the fact that a particular user was redirected to a particular redirection URI in response to a request with a particular request URI. There are many well-known ways a represent such a relation, including lists and hash tables. The association between a bookmark and a request URI that has been redirected consists of the mapping from the bookmark to a redirection URI in the bookmark mapping 130 plus a mapping from the browser user's identity and that redirection URI deduced from the past-redirections relation 150. The association between a bookmark and a request URI that has not been redirected consists simply of the mapping from the bookmark to that request URI in the bookmark mapping.

If the user of a web browser 110 requests the retrieval of the content associated with a bookmark, the web browser will send to the web server 120 the URI that bookmark mapping 130 associates with the bookmark. If the URI is one that the browser obtained, on behalf of the same user, as the result of a previous redirection, the past-redirections relation 150 will have a record of the previous redirection, including the original request URI, and the web server will process the new request as if it contains the original request URI. If the corresponding web content has moved since the previous redirection, this processing may result in a new redirection to a different redirection URI.

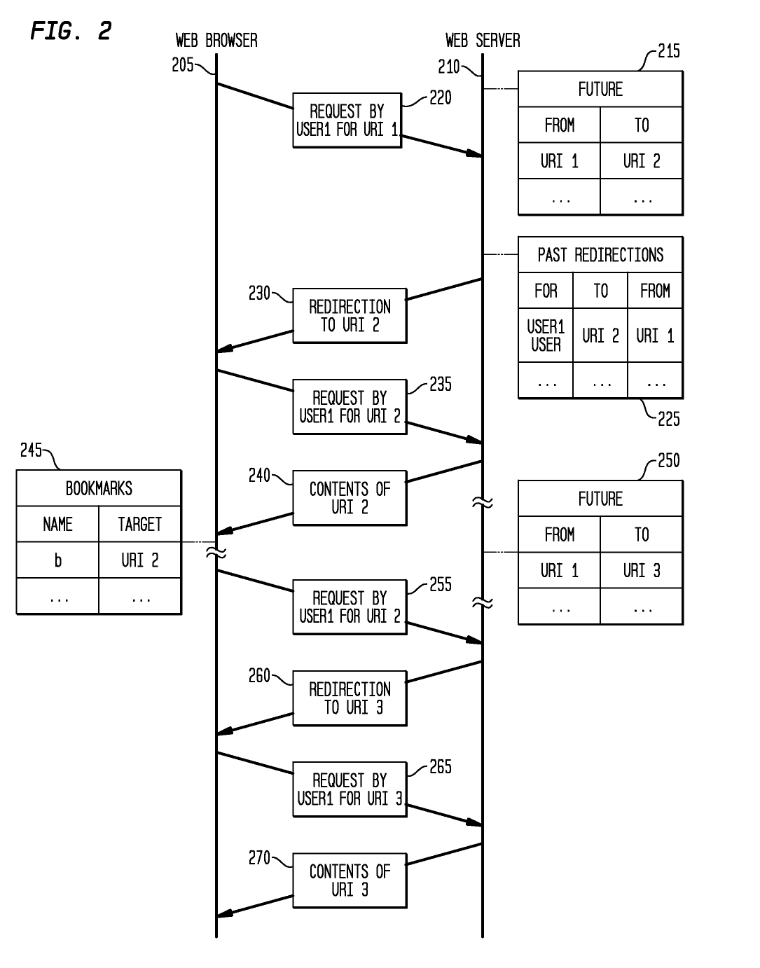

The activity diagram in FIG. 2, consisting of web-browser timeline 205 and web-server timeline 210, provides an example. The future-redirections mapping 215 on the web server specifies that requests for URI 1 should be redirected to URI 2. Web-browser user “user1” sends HTTP request 220 to the web server, containing URI 1 as its request URI. The web server consults its future-redirections mapping 215, determines that the request should be redirected to URI 2, records the redirection in past-redirections relation 225, and returns HTTP redirection response 230 to the web browser, containing URI 2 as its redirection URI. Upon receiving this response, the web browser issues HTTP request 235 to the web server, containing URI 2 as its request URI, and the web server returns HTTP response 240, which includes web-page content. The user of the web browser bookmarks this web page using bookmark name “b” and the browser device records this fact in bookmark mapping 245. Some time later, the administrator of the server moves the content that was previously at URI 2 to URI 3, and replaces the future-redirections mapping 215 with an updated future-redirections mapping 250 specifying that requests for URI 1 should be redirected to URI 3. Some time after this, web-browser user “user1” calls for the retrieval of the web page bookmarked as “b”. Because bookmark mapping 245 maps bookmark name “b” to URI 2, the web browser issues HTTP request 255, containing URI 2 as its request URI. The web server consults its past-redirections table 225, determines that user “user1” was previously redirected to URI 2 in response to a request for URI 1, and processes the newly arrived request as if it were a request for URI 1. Specifically, the web server consults its future-redirections mapping 250, determines that the request for URI 1 should be redirected to URI 3, and returns HTTP redirection response 260 to the web browser, containing URI 3 as its redirection URI. Upon receiving this response, the web browser issues HTTP request 265 to the web server, containing URI 3 as its request URI, and the web server returns HTTP response 270, which includes web-page content.

This URI redirection-management functionality implemented at the server device is embodied as a service and comprises all of the computer readable instructions, data structures, program modules, objects, and other configuration data for providing this redirection-management service for the benefit of the users.

It is possible for the same user to issue HTTP requests with two distinct request URIs, both of which are redirected to the same redirection URI. There are various ways in which the web server can deal with such an eventuality. One approach is to save only the most recent tuple in the past-redirections relation for a given combination of user and redirection URI. Another approach is to save all such tuples, and return a dynamically generated web page prompting the user to select from among the various request URIs. (The past redirection URI may also be presented as an option.)

It will be recognized that the past-redirections relation 150 can be replaced by a past-redirections mapping from redirection URIs to corresponding request URIs, without distinguishing among the various users whose requests were redirected; this implementation is more efficient in terms of time and space, but potentially less accurate. It will be further recognized that rather than constructing such a past-redirections mapping incrementally each time it returns a redirection response, the web server 120 can simply use the inverse of the future-redirections mapping.

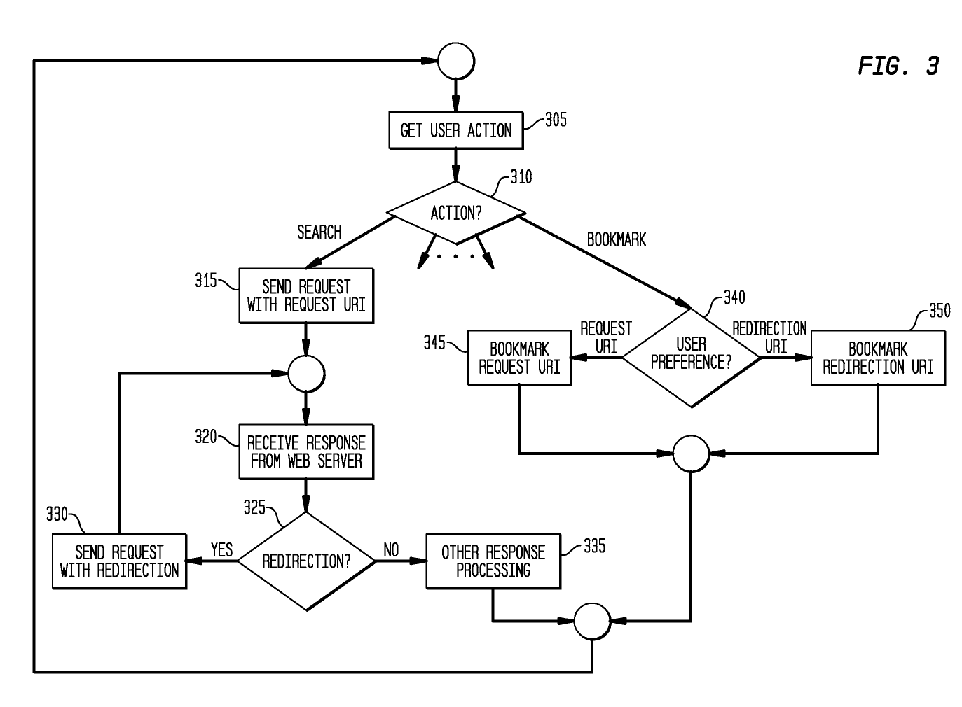

The browser-only aspect of the current invention entails a decision, at the time the user of the browser requests the bookmarking of a web page, to bookmark either the request URI or the redirection URI. FIG. 3 illustrates the relevant parts of the GUI-event loop of a browser implementing this aspect. Execution of the event-loop body begins with a step 305 in which a GUI action, such as a mouse click selecting an item from a menu, is received, and a step 310 in which control is passed to the appropriate piece of code to handle that kind of action. A common implementation of these steps is the registration of event handlers, or listeners, to handle the processing associated with a particular kind of action, and a loop that repeatedly receives GUI events and invokes the appropriate event handlers. There are many kinds of GUI events that a browser must handle, but for the purposes of illustration, two of them are now described: 1) the handling of a request to perform a search using a given request URI, and 2) the handling of a request to bookmark the currently displayed web page.

In the case of a request to perform a search using a given request URI, the browser performs a step 315 in which it sends an HTTP request to the web server containing the request URI. In a step 320, the browser receives an HTTP response from the web server, and in a step 325 the browser examines the HTTP response to determine whether it is a redirection response. In the case of a redirection response, the browser executes a step 330 to issue a new HTTP request using the redirection URI, and loops back to repeat the processing starting at 320. The loop enables the browser to follow a chain of multiple redirections. In the case of an HTTP response other than a redirection response, a step 335 performs the processing appropriate for that response, which is beyond the scope of the current invention, completing this iteration of the event-loop body.

In the case of a request to bookmark the currently displayed web page, the browser executes a decision step 340 to determine which URI should be bookmarked, the original request URI sent in step 315 or, the final redirection URI processed in step 330. In the former case a step 345 bookmarks the request URI, and in the latter case a step 350 bookmarks the redirection URI, completing this iteration of the event-loop body.

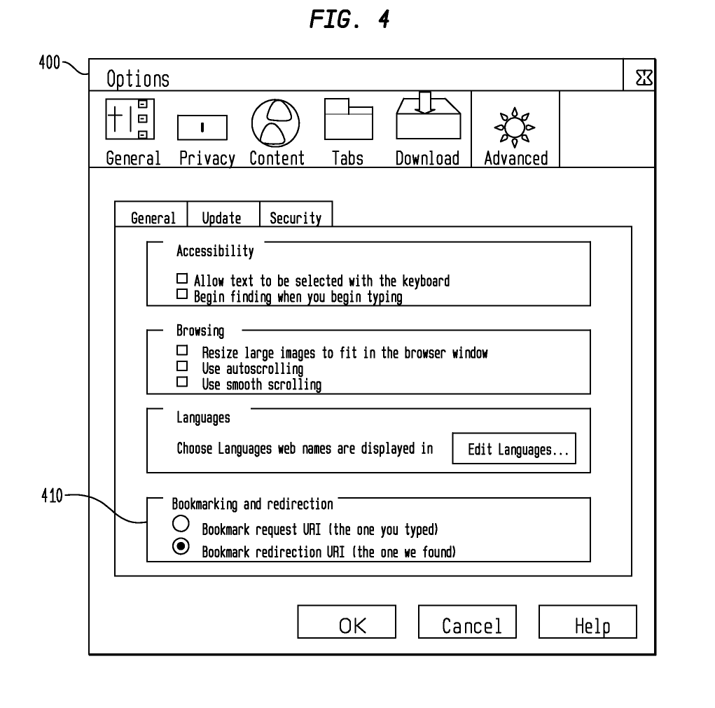

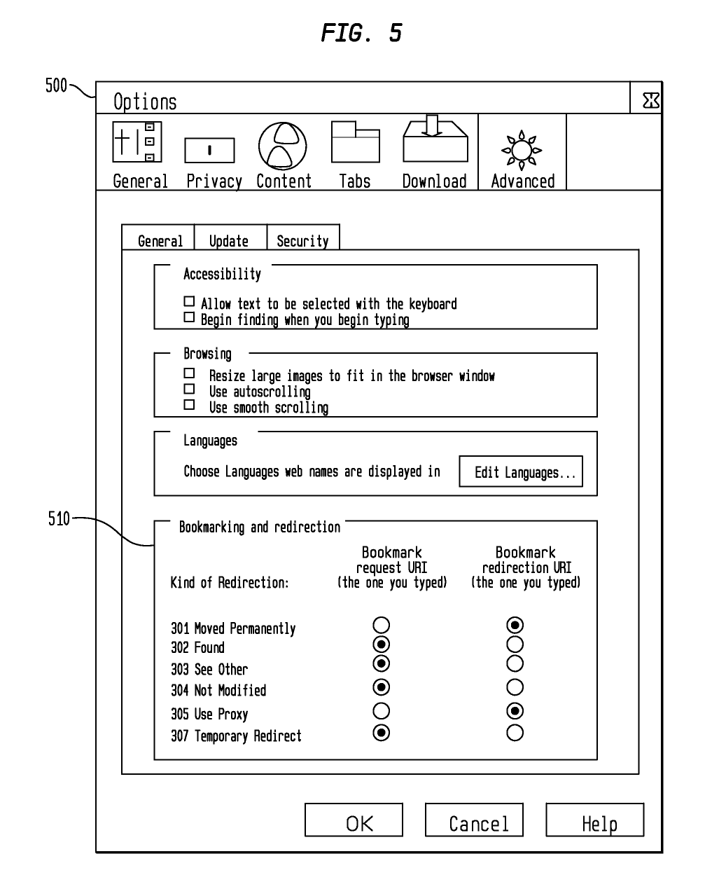

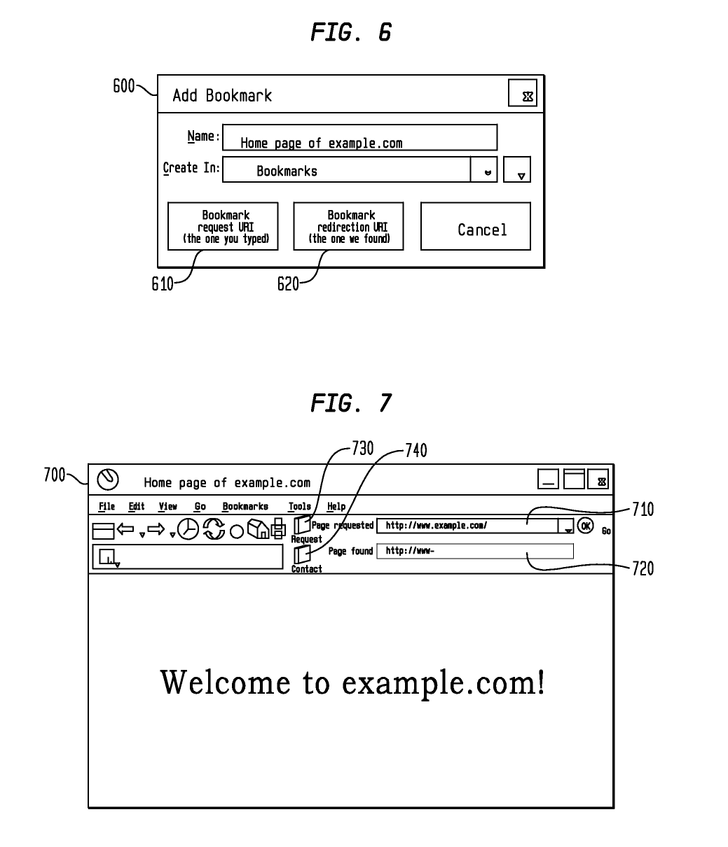

There are several ways in which a browser can execute decision step 340. A degenerate case of the decision step is simply to use the request URI in all cases. As explained herein, this is often, but not always, the best response. The following alternatives offer more control to the user of the browser:
As illustrated in FIG. 4, the browser can offer an options dialog 400 that includes a control 410 for the user to specify a permanent preference that applies to all redirections.
As illustrated in FIG. 5, the browser can offer an options dialog 500 that includes a control 510 for the user to specify distinct permanent preferences for each HTTP redirection-response status code 301-307. Thus, as shown in FIG. 5, via exemplary GUI 500, a user can create a bookmark associated with a request URI entered by the user, or create a bookmark redirection URI that was found by the server.
As illustrated in FIG. 6, each time the user requests that a URI found through redirections be bookmarked, the browser can present an “Add Bookmark” dialog 600 that offers the user one button 610 to press in order to bookmark the request URI and another button 620 to be pressed in order to bookmark the redirection URI that was found.
As illustrated in FIG. 7, a browser window 700 may be generated that includes a toolbar with two address fields, a read-write field 710 in which the user types a request URI, and a read-only field 720 in which the browser indicates the URI of the page actually displayed. There are separate user-selectable buttons or icons—a first button 730 provided that, when selected, will enable a user to bookmark the URI entered by the user and a second button 740 to bookmark the URI found by the browser. (These two URIs may differ not only because of redirection, but also because of automatic transformation of the URI by the browser, for example from “example.com” to http://www.example.com/.

It will be recognized that there are many variations possible in the kind of control the user of the browser is given over the selection of a URI to be bookmarked, and many variations in the design of a user interface to communicate the user's decisions. The examples listed above are illustrative, and not meant to be exhaustive.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

What is claimed is:

1. A method of retrieving, in response to a later HTTP request by a requester, a web page retrieved by a browser device in response to an earlier redirected HTTP request, said method comprising:
at a server device, generating a redirection response to said earlier redirected HTTP request, and generating and storing a record associating the redirection URI in said redirection response with the request URI in said earlier redirected HTTP request;
storing, at said browser device, said redirection URI in a bookmark;
retrieving, at said browser device, the URI associated with said bookmark by issuing said later HTTP request, using the redirection URI stored in said bookmark as the request URI of said later HTTP request;
receiving, at said server device, said later HTTP request and searching for a record associating the request URI of said later HTTP request with the request URI of some earlier redirected HTTP request;
upon finding such a record, said server device processing said later HTTP request as if its request URI were said request URI of some earlier redirected HTTP request in said found record,
wherein a web page identified by the request URI of said earlier redirected HTTP request is retrieved through said bookmark.

2. The method as in claim 1, wherein a server device, upon generating a redirection response to said earlier redirected HTTP request, generates and stores a record associating the redirection URI in said redirection response and an identity of the requester with the request URI in said earlier redirected HTTP request;
said server device receiving said later HTTP request and searching for a record associating the request URI and the identity of the requester of said later HTTP request with the request URI of some earlier redirected HTTP request; and,
said server device, upon finding such a record, processes said later HTTP request as if its request URI were said request URI of some earlier redirected HTTP request in said found record.

3. The method as in claim 1, wherein a first server device, upon generating a redirection response to said earlier redirected HTTP request, generates and stores, in a repository accessible to a second server device, a record associating the redirection URI in said redirection response with the request URI in said earlier redirected HTTP request;
said second server device receiving said later HTTP request and searching in said repository for a record associating the request URI of said later HTTP request with the request URI of some earlier redirected HTTP request; and
said second server device, upon finding such a record, processing said later HTTP request as if its request URI were said request URI of some earlier redirected HTTP request in said found record.

4. A method of bookmarking a web page by a browser device as a result of issuing an HTTP request with a given request URI that resulted in a redirection response from a server device, said method comprising:
receiving an HTTP response from the server device, and
creating, at said browser device, at the initiation of the user of the browser device, a bookmark for the given request URI in said HTTP request, even if the request was redirected to another URI by said server device.

5. The method of bookmarking a web page by a browser device as claimed in claim 4, further comprising, prior to said creating:
determining whether the HTTP response received is a redirection response from said server device; and, in response to said determining,
enabling said browser device to create, at the initiation of the user of the browser, one of: a bookmark referring to the original given request URI that was subject to redirection, or a bookmark referring to the redirection URI in said received HTTP response.

6. The method of bookmarking a web page by a browser device as claimed in claim 4, further comprising:
setting, at said browser device, an option that enables automatic bookmarking of the original given request URI for all received redirection responses.

7. The method of bookmarking a web page by a browser device as claimed in claim 4, further comprising:
setting, at said browser device, an option that stipulates automatic bookmarking of the original given request URI for all redirection responses associated with a given status code.

8. The method of bookmarking a web page by a browser device as claimed in claim 4, further comprising:
providing a user-interface element suitable for display via said browser device enabling the user of said browser device to direct storing of the original given request URI as a bookmark,
displaying said user-interface element when the user of the browser requests the creation of a bookmark and the currently displayed page was reached by redirection.

9. The method of bookmarking a web page by a browser device as claimed in claim 8, wherein said user-interface element displayed at said browser device comprises:
an address field associated with each of the given request-URI and the redirection URI, and a user-interface button associated with each address field operable for selecting said request for creating of a bookmark,
wherein the user controls whether the given request URI will be stored in the bookmark by clicking the button associated with the given request-URI.

10. A program storage device readable by a machine, tangibly embodying a program of instructions executable by the machine to perform method steps of retrieving, in response to a later HTTP request, a web page retrieved by a browser device in response to an earlier redirected HTTP request, the method comprising:
at a server device, generating a redirection response to said earlier redirected HTTP request, and generating and storing a record associating the redirection URI in said redirection response with the request URI in said earlier redirected HTTP request;
storing, at said browser device, said redirection URI in a bookmark;
retrieving, at said browser device, the URI associated with said bookmark by issuing said later HTTP request, using the redirection URI stored in said bookmark as the request URI of said later HTTP request;
receiving, at said server device, said later HTTP request and searching for a record associating the request URI of said later HTTP request with the request URI of some earlier redirected HTTP request;
upon finding such a record, said server device processing said later HTTP request as if its request URI were said request URI of some earlier redirected HTTP request in said found record,
wherein a web page identified by the request URI of said earlier redirected HTTP request is retrieved through said bookmark.

11. The program storage device readable by a machine as in claim 10, wherein a server device, upon generating a redirection response to said earlier redirected HTTP request, generates and stores a record associating the redirection URI in said redirection response and an identity of the requester with the request URI in said earlier redirected HTTP request;
said server device receiving said later HTTP request and searching for a record associating the request URI and the identity of the requester of said later HTTP request with the request URI of some earlier redirected HTTP request; and,
said server device, upon finding such a record, processes said later HTTP request as if its request URI were said request URI of some earlier redirected HTTP request in said found record.

12. The program storage device readable by a machine as in claim 10, wherein a first server device, upon generating a redirection response to said earlier redirected HTTP request, generates and stores, in a repository accessible to a second server device, a record associating the redirection URI in said redirection response with the request URI in said earlier redirected HTTP request;
said second server device receiving said later HTTP request and searching in said repository for a record associating the request URI of said later HTTP request with the request URI of some earlier redirected HTTP request; and
said second server device, upon finding such a record, processing said later HTTP request as if its request URI were said request URI of some earlier redirected HTTP request in said found record.

13. A program storage device readable by a machine, tangibly embodying a program of instructions executable by the machine to perform method steps of bookmarking a web page by a browser device as a result of issuing an HTTP request with a given request URI that resulted in a redirection response from a server device, said method comprising:
receiving an HTTP response from the server device, and
creating, at said browser device, at the initiation of the user of the browser device, a bookmark for the given request URI in said HTTP request, even if the request was redirected to another URI by said server device.

14. The program storage device readable by a machine as claimed in claim 13, further comprising, prior to said creating:
determining whether the HTTP response received is a redirection response from said server device; and, in response to said determining,
enabling said browser device to create, at the initiation of the user of the browser, one of: a bookmark referring to the original given request URI that was subject to redirection, or a bookmark referring to the redirection URI in said received HTTP response.

15. The program storage device readable by a machine as claimed in claim 13, further comprising:
setting, at said browser device, an option that enables automatic bookmarking of the original given request URI for all received redirection responses.

16. The program storage device readable by a machine as claimed in claim 13, further comprising:
setting, at said browser device, an option that enables automatic bookmarking of the original given request URI for all redirection responses associated with a given status code.

17. The program storage device readable by a machine as claimed in claim 13, further comprising:
providing a user-interface element suitable for display via said browser device enabling the user of said browser device to direct storing of the original given request URI as a bookmark,
displaying said user-interface element when the user of the browser requests the creation of a bookmark and the currently displayed page was reached by redirection.

18. The program storage device readable by a machine as claimed in claim 17, wherein said user-interface element displayed at said browser device comprises:
an address field associated with each the given request-URI and the redirection URI, and a user-interface button associated with each address field operable for selecting said request for creating of a bookmark,
wherein the user controls whether the given request URI be stored in the bookmark by clicking the button associated with the given request-URI.

19. A system for retrieving web pages comprising:
a computing device for receiving an HTTP request with a given request URI;
a means implemented in said computing device for determining whether a given request URI results in a redirection response and providing a redirection URI in response to a given request that results in said redirection;
a means associated with said computing device for generating a data structure associating the given redirection URI returned in response to a request with said given request URI;
a storage means for storing said generated data structure;
a browser device for storing a bookmark associated with a URI, the redirection URI being returned by the computing device in said bookmark, said browser device retrieving the URI associated with said bookmark by issuing an HTTP request including the redirection URI stored in said bookmark; and,
a means implemented in said computing device for searching for said data structure of the given URI having been returned as a redirection URI in response to a request with a request URI, and, upon accessing said data structure, initiating said computing device to process the given HTTP request as if it contained the given request URI,
wherein a web page identified by the given request URI associated with the given stored bookmark is retrieved.

20. The system as claimed in claim 19, wherein said means associated with said computing device for generating a data structure further generates a unique record associating the given redirection URI returned in response to a request with said given request URI for each user of the browser device, wherein in response to receiving, at said computing device, a given HTTP request with a given request URI from a given user, said searching means searches for said record of the given URI having been returned as a redirection URI in response to a request from said given user with some request URI; and, upon accessing said record, initiating said computing device to process the given HTTP request as if it contained the given request URI.

21. The system as claimed in claim 19, wherein said computing device generating a data structure associating the given redirection URI returned in response to a request with said given request URI is the same as said computing device receiving said given HTTP request with a given URI.

22. The system as claimed in claim 19, wherein said computing device generating a record associating the given redirection URI returned in response to a request with said given request URI is different from said computing device receiving said given HTTP request with a given URI.

23. A service for providing HTTP responses in response to HTTP requests comprising:
receiving HTTP requests at a computing device, each HTTP request associated with a given original request URI;
determining, at said computing device, whether a given request URI results in a redirection response and providing a redirection URI in response to a given original request that results in said redirection; and
responding at said computing device to any subsequent HTTP request from the same requester in which the request URI is the given redirection URI as if the request URI in the subsequent HTTP request were replaced by the given original request URI.
